(19) United States
(12) Patent Application Publication
(10) Pub. No.: US 2009/0150928 A1
(43) Pub. Date: Jun. 11, 2009

(54) Video apparatus with picture/text messaging function

(76) Inventors: Ming-Jen Hsu, Taipei City (TW); Yu-Cheng Chen, Kaohsiung City (TW); Shih-Chang Chen, Shinfeng Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,841

(22) Filed: Feb. 27, 2008

(30) Foreign Application Priority Data
Dec. 5, 2007 (TW) 96146260

(51) Int. Cl. H04N 7/025

(52) U.S. Cl. 725/34

(57) ABSTRACT

A video apparatus with a picture/text messaging function includes a multifunctional decoder, a video decoder, an image processor and a display. The multifunctional decoder receives texts, pictures or videos from an external device, and decoding the texts, pictures or videos to output a text signal and an image signal. The video decoder is connected to the multifunctional decoder to receive the image signal and decode the image signal. The image processor is connected to the multifunctional decoder and the video decoder to receive the text signal and the decoded image signal and to output a picture/text messaging signal. The display is connected to the image processor to receive the picture/text messaging signal to display picture and text messages.

### BACKGROUND OF THE INVENTION

1. Field of the Invention

The invention generally relates to a video apparatus with a picture/text messaging function, and more particularly to a video apparatus which allows picture/text messaging via various input interfaces.

2. Description of the Related Art

Television sets have been used as domestic appliances to supply the user images and audio transmissions (audios) for entertainment, learning and other purposes.

Usually, television sets are used to display TV programs with images and audios, and also provide display functions when connected to an external video player such as a Video Compact Disc (VCD) player or Digital Versatile Disk (DVD) player, or a computer. The television set only outputs the images and audios that the playing VCD or DVD has, or outputs the content transmitted from the computer.

As the television sets are necessary and most-used domestic appliances for families, they attract most attention when people are at home. If family members are in different rooms or locations and not available to talk all the time, then the interaction between them may be very small.

### SUMMARY OF THE INVENTION

It is an object of the invention to provide a video apparatus with picture/text messaging function. The video apparatus can be such as displays, television sets or mobile phones with fonts in multiple languages and compression functions for multimedia audios, videos or pictures. Furthermore, the video apparatus can display all messages, including texts, multimedia videos, audios or pictures, from various interfaces so that the user can view the messages while watching television programs.

As a first aspect of the invention, a video apparatus with a picture/text messaging function includes a multifunctional decoder, a video decoder, an image processor and a display. The multifunctional decoder receives texts, pictures or videos from an external device, and decodes the texts, pictures or videos to output a text signal and an image signal. The video decoder is connected to the multifunctional decoder to receive the image signal and decode the image signal. The image processor is connected to the multifunctional decoder and the video decoder to receive the text signal and the decoded image signal to output a picture/text messaging signal. The display is connected to the image processor to receive the picture/text messaging signal for displaying picture and text messages. The memory further stores the audio signal which then is transmitted to the speaker under the control of the sound switch.

In light of the foregoing, the video apparatus, such as display, television set or mobile phone, which the invention adds the picture/text messaging function, receives the messages such as multimedia videos, audios, pictures or texts and displays those messages on its screen along with the television programs.

When the video apparatus is turned on, the messages will be shown along with the television program on the display. Thereby, the user view or hear the unread messages as soon as he or she turns on the television set and won't miss the messages while watching the television programs. The video apparatus can be also added value to the communication among family members when the family are at different locations or rooms and not available to talk all the time.

As a second aspect of the invention, the video apparatus of this aspect is almost the same as the first aspect, except that a sound switch an a speaker are further included, and the multifunctional decoder further receives an external audio and decodes the audio to output an audio signal which then transmitted to the speaker under the control of the sound switch. The memory further stores the audio.

To provide a further understanding of the invention, the following detailed description illustrates embodiments and examples of the invention, this detailed description being provided only for illustration of the,invention.

### BRIEF DESCRIPTION OF THE DRAWINGS

FIG. 1 is a schematic view showing a video apparatus with a picture/text messaging function in use according to one embodiment of the invention.

FIG. 2 is a schematic view of a video apparatus according to one embodiment of the invention.

FIG. 3 is a schematic view of a video apparatus according to another embodiment of the invention.

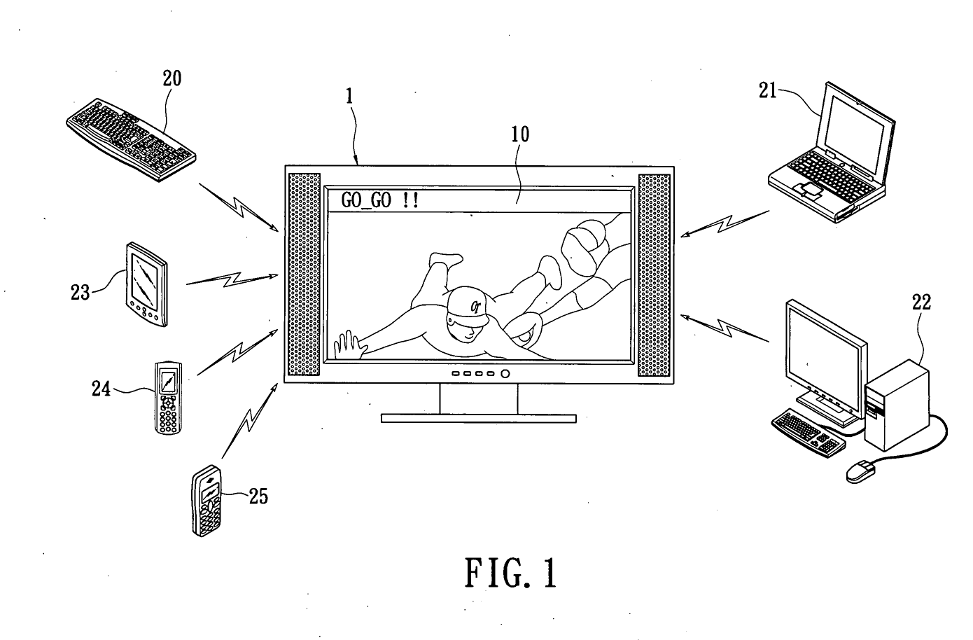

### DETAILED DESCRIPTION OF THE EMBODIMENTS

Wherever possible in the following description, like reference numerals will refer to like elements and parts unless otherwise illustrated. FIG. 1 is a schematic view showing a video apparatus with a picture/text messaging function in use according to one embodiment of the invention. In FIG. 1, the video apparatus 1 with the picture/text messaging function according to the invention communicates with a key board 20 via interfaces such as Recommended Standard 232 (RS232), Universal Serial Bus (USB) or Personal System 2 (PS2) to get texts from the input of the key broad 20. The video apparatus 1 also communicates with a remote control 24 via infrared (IR) interface so as to get the texts from the input of the remote control 24. The video apparatus 1 also communicates with a personal computer 22 or a laptop 21 via Wireless Local Area Network (WLAN) or Local Area Network (LAN) to get texts, audios, videos or pictures from the input of the personal computer 22 or the laptop 21. Furthermore, the video apparatus 1 communicates with a personal digital assistant (PDA) 23, a mobile phone 25 via wireless interfaces such as Bluetooth, ZigBee, Wi-Fi, Global System for Mobile communications (GSM) or Code Division Multiple Access (CDMA) to get texts, audios, videos or pictures from the input of the personal digital assistant (PDA) 23 or the mobile phone 25.

Referring to FIG. 1, the video apparatus of the invention can be, for example, a display, a television set, or a hand-held display apparatus. The video apparatus 1 has built-in fonts in multiple languages and a compression function for multi-media audios, videos and pictures. The video apparatus 1 also can show messages 10 such as texts, multi-media audios, videos or pictures sent from various interfaces so that the user is allowed to view the messages 10 while watching the videos or TV programs.

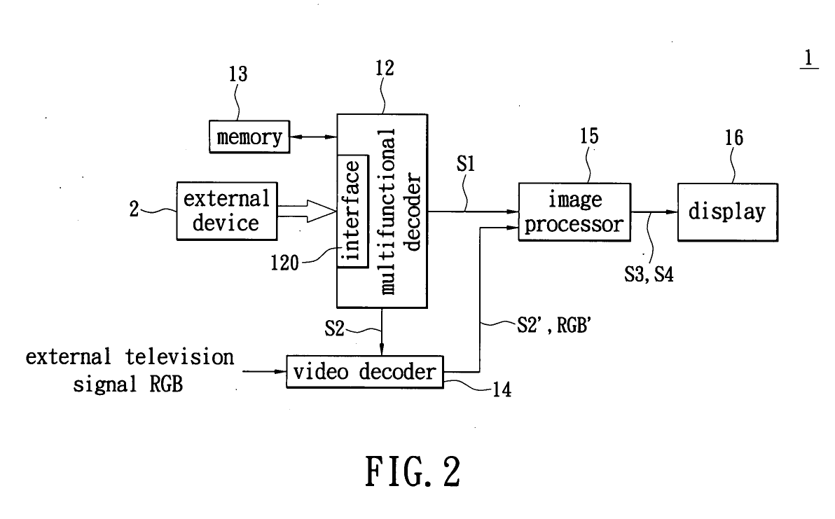

FIG. 2 is a schematic view of a video apparatus according to one embodiment of the invention. The video apparatus 1 has a multifunctional decoder 12, a memory 13, a video decoder 14, an image processor 15 and a display 16. The multifunctional decoder 12 connects to an external device 2 via an interface 120, and receives texts, pictures or videos from the external device 2. The multifunctional decoder 12 has a wording engine (not shown) and a multimedia audio/video engine (not shown). The wording engine decodes the texts and outputs a text signal S1. The multimedia audio/video engine decodes the pictures, audios or videos and outputs an image signal S2.

Referring to FIG. 2, the memory 13 connects to the multifunctional decoder 12 to restore the texts, the pictures or the videos. The video decoder 14 connects to the multifunctional decoder 12 to receive the image signal S2 from the multifunctional decoder 12 and decode the image signal S2. The video decoder 14 further receives an external television signal RGB and decodes it. Furthermore, the video decoder 14 offers a 3D comb filtering function to enhance the frame quality of the image signal S2 and the television signal RGB.

The image processor 15 connects to the multifunctional decoder 12 and the video decoder 14 to receive the text signal S1, the decoded image signal S2′ and the decoded television signal RGB′, and then outputs a picture/text messaging signal S3 and a program signal S4. The display 16 connects to the image processor 15 to receive the picture/text messaging signal S3 and a program signal S4, and then displays the corresponding pictures, texts and television programs. The image processor 15 tunes up the text signal S1, the decoded image signal S2′ and the decoded television signal RGB′ according to characters of the display 16 for optimal display of the pictures, the texts and the television programs.

Referring to FIG. 2, the user can use the external device 2 to transmit all messages such as texts, pictures or videos via various interfaces 120 to the video apparatus 1. When the video apparatus 1 is turned on, the messages will be shown along with the television program on the display 16.

Thereby, the user view or hear the unread messages as soon as he or she turns on the television set and won't miss the messages while watching the television programs. The video apparatus 1 can be also applied to the communication among family members when they are at different locations or rooms and not available all the time to talk.

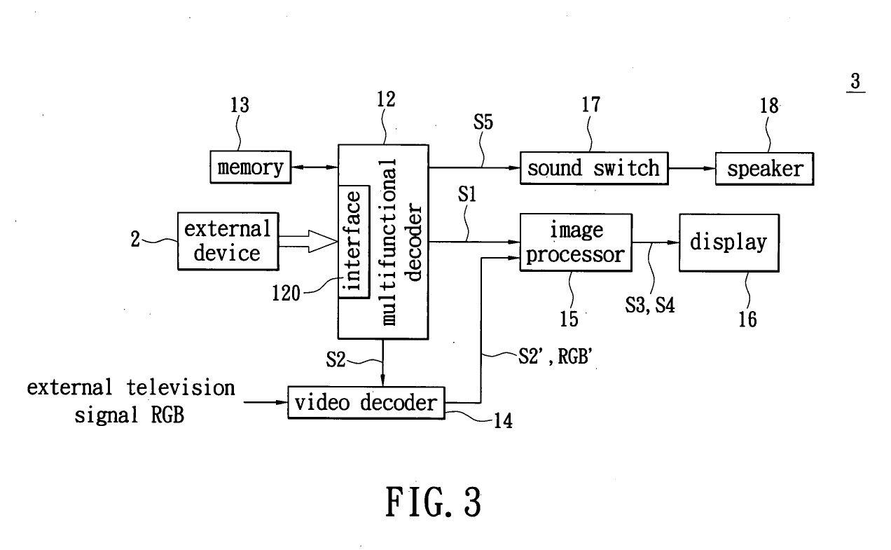

FIG. 3 is a schematic view of a video apparatus according to another embodiment of the invention. In this embodiment, the same reference numeral indicates the same device as the above. The video apparatus 3 has a multifunctional decoder 12, a memory 13, a video decoder 14, an image -processor 15, a display 16, a sound switch 17 and a speaker 18. The multifunctional decoder 12 receives multimedia audios, videos, pictures and sounds from the external device 2. The multifunctional decoder 12 uses the multimedia audio/video engine (not shown) to decode the sounds and then outputs a sound signal S5. The sound signal S5 is output to the speaker 18 under the control of the sound switch 17 to achieve the sound messaging purpose.

Referring to FIG. 3, the user can use the external device 2 to transmit the messages such as texts, audios, videos or pictures via the various interfaces 120 to the video apparatus 3. When the video apparatus 3 is turned on, the messages will be shown along with the television program on the display 16. Furthermore, the speaker 18 can be used to output the messages in form of sounds.

Thereby, the user view or hear the unread messages as soon as he or she turns on the television set and won't miss the messages while watching the television programs. The video apparatus 1 can be also applied to the communication among family members when they are at different locations or rooms and not available all the time to talk.

It should be apparent to those skilled in the art that the above description only illustrates specific embodiments and examples of the invention. However, the invention should cover various modifications and variations made to the herein-described structure and operations of the invention, provided they fall within the scope of the invention as defined in the following appended claims.

What is claimed is:

1. A video apparatus with a picture/text messaging function, comprising:
a multifunctional decoder, receiving texts, pictures or videos from an external device, and decoding the texts, pictures or videos to output a text signal and an image signal;
a video decoder, connected to the multifunctional decoder to receive the image signal and decode the image signal;
an image processor, connected to the multifunctional decoder and the video decoder to receive the text signal and the decoded image signal and output a picture/text messaging signal; and
a display, connected to the image processor to receive the picture/text messaging signal to display picture and text messages.

2. The video apparatus of claim 1, further comprising a memory connected to the multifunctional decoder to store the texts, pictures and the videos.

3. The video apparatus of claim 2, wherein the multifunctional decoder has a wording engine and a multimedia audio/video engine, the wording engine decoding the texts and outputting the text signal, and the multimedia audio/video engine decoding the pictures or videos and outputting the image signal.

4. The video apparatus of claim 3, wherein the texts, the pictures and the videos are transmitted via USB, WLAN, LAN, Bluetooth, ZigBee, PS2 or IR.

5. The video apparatus of claim 4, wherein the texts, the pictures and the videos are transferred from a key board, a personal computer, a laptop, a personal digital assistant, a mobile phone or a remote control.

6. The video apparatus of claim 3, wherein the video decoder offers a 3D comb filtering function to enhance the frame quality of the image signal.

7. The video apparatus of claim 6, wherein the video decoder further receives an external television signal so as to decode the television signal and enhance the frame quality of the television signal.

8. The video apparatus of claim 7, wherein the image processor receives the text signal, the decoded image signal and the decoded television signal, and tunes up the text signal, the decoded image signal and the decoded television signal so as to show the pictures, the texts and the television programs on the display.

9. The video apparatus of claim 1, wherein the multifunctional decoder further receives an external audio signal and decodes the received audio signal.

10. The video apparatus of claim 9, further comprising a memory connected to the multifunctional decoder to store texts, audios, videos and pictures.

11. The video apparatus of claim 10, wherein the multifunctional decoder has a wording engine and a multimedia audio/video engine, the wording engine decoding the texts and outputting the text signal, and the multimedia audio/video engine decoding the pictures, audios or videos and outputting the image signal and an audio signal.

12. The video apparatus of claim 11, wherein the texts, pictures, audios and videos are transmitted via USB, WLAN, LAN, Bluetooth, ZigBee, PS2 or IR.

13. The video apparatus of claim 12, wherein the texts, pictures, audios and videos are transmitted from a key board, a personal computer, a laptop, a personal digital assistant, a mobile phone or a remote control.

14. The video apparatus of claim 11, further comprising a sound switch connected to a speaker, where the sound switch is further connected to the multifunctional decoder, and the audio signal is output to the speaker under the control of the sound switch.

15. The video apparatus of claim 14, the video decoder offering a 3D comb filtering function to enhance the frame quality of the image signal.

16. The video apparatus of claim 15, wherein the video decoder further receives an external television signal so as to decode the television signal and enhance the frame quality of the television signal.

17. The video apparatus of claim 16, wherein the image processor receives the text signal, the decoded image signal and the decoded television signal, and tunes up the text signal, the decoded image signal and the decoded television signal so as to show the pictures, the texts and the television programs on the display.
